(19) United States
(12) Patent Application Publication
(10) Pub. No.: US 2012/0273608 A1
(43) Pub. Date: Nov. 1, 2012

(54) HYBRID LIFT AIR VEHICLE

(76) Inventors: Peter E. Jess, Calgary (CA); Ken Laubsch, Mullica Hill, NJ (US)

(21) Appl. No.: 12/999,309

(22) PCT Filed: May 21, 2009
(86) PCT No.: PCT/CA09/00710

§ 371 Date: Dec. 5, 2011

(30) Foreign Application Priority Data
Jun. 16, 2008 (CA) 2,635,096

(51) Int. Cl. B64B 1/34

(52) U.S. Cl. 244/26

(57) ABSTRACT

A hybrid lift air vehicle for carrying and transporting a load, comprising an envelope having a generally ellipsoidal shape adapted to receive a volume of lighter-than-air gas, at least two variable thrust vertical thrusters in secure engagement with the envelope and at least two variable thrust lateral thrusters in secure engagement with the envelope, means for temporarily securely engaging the load to the envelope wherein the volume of lighter-than-air gas has a buoyancy that offsets at least 25% of the weight of the air vehicle when unloaded, wherein the thrust from the at least two vertical thrusters may be varied to raise and lower the air vehicle and the load when engaged, and wherein the thrust from the at least two lateral thrusters may be varied to maneuver and transport the raised air vehicle and the load when engaged.

### FIELD OF THE INVENTION

The present invention relates to an improved hybrid lift air vehicle for lifting and transporting heavy payloads and more particularly relates to an improved hybrid lift air vehicle utilizing helium or another lighter-than-air gas contained within an envelope to offset all, or substantially all of the weight of the air vehicle when without a payload, the vehicle also having vertical thrusters consisting of rotors or propellers to lift all, or substantially all of the weight of the payload when the vehicle is loaded.

### BACKGROUND OF THE INVENTION

The transport of heavy loads in regions where there is little or no infrastructure continues to present a significant challenge to private ventures and government agencies. As a result, the development of natural resources or provision of government services in remote regions is often costly, unreliable or inadequate.

In certain regions, as particularly in the arctic, harsh climate, difficult conditions and the need to preserve the environment add additional challenges. Although roads offer a solution, such roads are costly and damage the environment. In the arctic, ice roads may be used, but these are useful only during the winter months and are unreliable due to unpredictable timing of spring thaw. Other transportation methods in remote areas of muskeg, permafrost and open water have relied, at least seasonally, on air transportation with its inherent costs and the need for substantial infrastructure to support it.

Lighter-than-air (LTA) devices, such as aerostats or airships, are known in the art for lifting and transporting passengers and/or a payload. In general, such LTA devices are constituted by an envelope containing helium or other lighter-than-air gases, such as neon, methane, ethane, or hydrogen. In some cases the lighter than air device may have a gondola or platform for a crew. A propulsion system attached to the LTA device is provided to move the airship through the air.

In principle, LTA airships are capable of lifting and transporting heavy loads or objects that are too bulky to be transported by truck, train, helicopter or airplane. Recently, lighter-than-air vehicles capable of transporting heavy loads have been proposed which may be used as a means to transport heavy loads in remote and arctic regions. While LTA vehicles may be fuel efficient and suitable for hauling heavy cargos long distances, the need for ballast exchange makes traditional airships impractical for hauling heavy loads in remote regions. In traditional airships that rely on lighter-than-air gases to lift 100% of the weight of both the cargo and the vessel itself, ballast exchange is required where a ballast material (typically water or sand) is taken aboard to replace the weight of the cargo as the cargo is unloaded in order to maintain neutral buoyancy. In the arctic and remote regions, the logistics associated with large ballast transfers associated with heavy loads presents substantial technical hurdles and costs. Even where water is available for ballast, substantial planning and support equipment is required to ensure accessibility of ballast sources and that when water ballast is being utilized, the water is maintained above freezing to ensure quick and efficient payload drops and ballast management.

To overcome some of the difficulties associated with transporting heavy payloads in remote and arctic environments, hybrid air vehicles, that is, air vehicles which derive some or a substantial part of their lift from lighter than air gas and some of their lift mechanically, such as, for example, by way of rotors, propellers or jet engines, have been proposed, as, for example, described in U.S. Pat. No. 4,685,640 (Warrington et al) in which the air vehicle has an envelope containing a lighter than air gas, and has downwardly directed fans to provide additional lift for the air vehicle.

It is desirable to provide hybrid air vehicles with improved aerodynamic efficiency, fuel efficiency, load capacity and range.

### SUMMARY OF THE INVENTION

Accordingly, one object of the present invention is to provide a hybrid air vehicle with improved aerodynamic efficiency.

Another object of the present invention is to provide to a hybrid air vehicle with improved fuel efficiency.

Another object of the present invention is to provide to a hybrid air vehicle with improved load capacity.

Another object of the present invention is to provide to a hybrid air vehicle with improved range.

According to one aspect of the present invention, there is provided a hybrid lift air vehicle for carrying and transporting a load, comprising, an envelope having a generally ellipsoidal shape adapted to receive a volume of lighter-than-air gas, at least two variable thrust vertical thrusters in secure engagement with the envelope and at least two variable thrust lateral thrusters in secure engagement with the envelope; and means for temporarily securely engaging the load to the envelope, wherein the volume of lighter-than-air gas has a buoyancy that offsets at least 25% of the weight of the air vehicle when unloaded, wherein the thrust from the at least two vertical thrusters may be varied to raise and lower the air vehicle and the load when engaged, and wherein the thrust from the at least two lateral thrusters may be varied to maneuver and transport the raised air vehicle and the load when engaged.

An advantage of the present invention is that it provides a hybrid air vehicle with improved aerodynamic efficiency.

A further advantage of the present invention is that it provides a hybrid air vehicle with improved fuel efficiency.

A further advantage of the present invention is that it provides a hybrid air vehicle with improved load capacity.

A further advantage of the present invention is that it provides a hybrid air vehicle with improved range.

### BRIEF DESCRIPTION OF THE DRAWINGS

A preferred embodiment of the present invention is described below with reference to the accompanying drawings, in which:

FIG. 1 is a perspective view from the rear of one embodiment of the present invention;

FIG. 2 is a perspective view of one of the vertical and lateral thrusters of one embodiment of the present invention;

FIG. 3 is a view of the keel, hoop frames and horizontal support members of one embodiment of the present invention;

FIG. 4 is a perspective view of another embodiment of the present invention;

FIG. 5 is a view of the hoop frames, hoop cables, keel and additional cabling of one embodiment of the present invention.

### DESCRIPTION OF THE PREFERRED EMBODIMENT

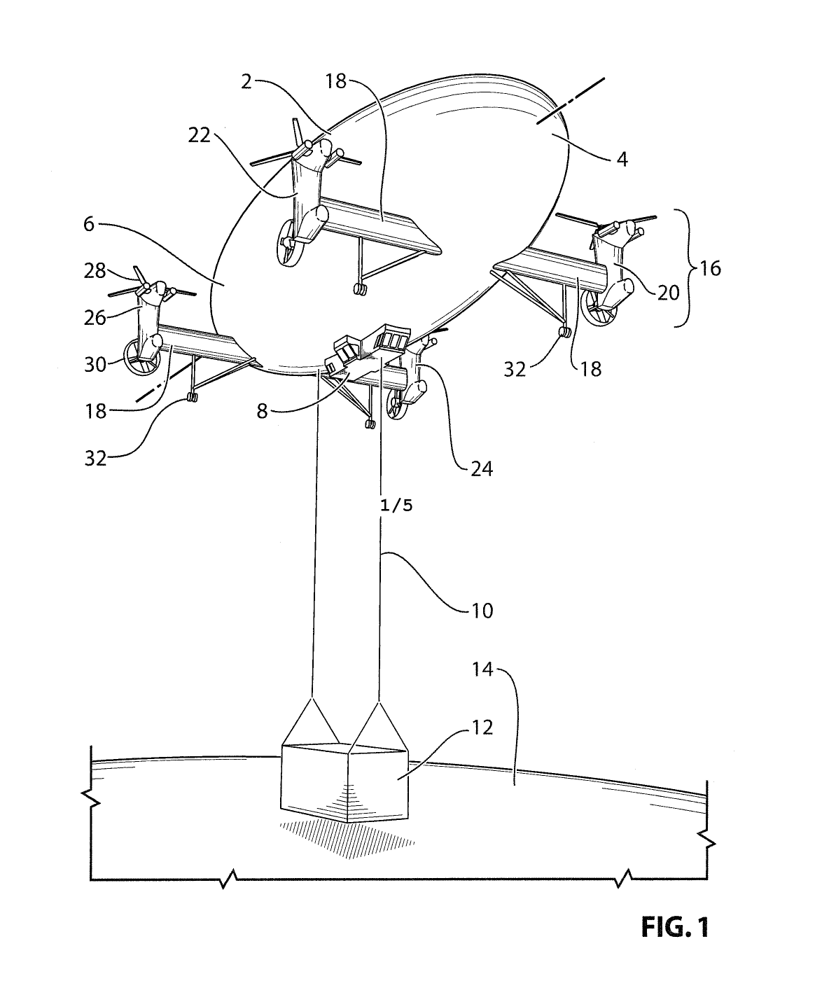

In a preferred embodiment of the present invention, as illustrated from below and the rear in FIG. 1, an air vehicle is provided for lifting and transporting loads, having, in a preferred embodiment, an envelope 2 preferably made of one or more layers of fabric including layers of MYLAR® or other suitable fabric known to a person skilled in the art and preferably having a generally ellipsoidal shape as more fully described herein, the envelope containing helium or another lighter than air gas (hereinafter referred to as “helium”).

### The Envelope

In the preferred embodiment of the present invention, the envelope 2 is of size so as to contain a sufficient volume of helium gas, under operational pressure (typically at or near atmospheric pressure), where the buoyancy of the helium gas fully or substantially offsets the weight of the entire air vehicle when unloaded rendering it fully or substantially neutrally buoyant when unloaded. In a preferred embodiment of the present invention, the generally ellipsoidal shape of the present invention preferably has a main axis to minor axis ratio of approximately 2.8:1 (it being understood that a wide range of main axis to minor axis ratios of between 100:1 to 1:1 are possible, while preferably the main axis to minor axis ratio is within a range of 8:1 to 1:1), the envelope in one embodiment of the present invention having a length of approximately 302 feet, a diameter (at the widest point) of 107 feet, and a volume of approximately 1807609 cubic feet (it being understood that a wide range of differently sized generally ellipsoidally-shaped envelopes may be utilized in alternative embodiments of the present invention as would be understood by a person skilled in the art). In a preferred embodiment of the present invention, the envelope is also adapted to receive therewithin one or more ballonets which may be used in a manner known to a person skilled in the art to manage the helium density within the envelope for the purposes of modifying and controlling the overall buoyancy, operational pressure and inclination of the air vehicle.

### The Gondola

The air vehicle preferably has a cockpit, bridge and crew module enclosure 8 (hereinafter collectively referred to as a “gondola”) positioned beneath the envelope 2, in which gondola 8 controls for maneuvering and operating the air vehicle, and controls for lifting and lowering loads are preferably positioned, the gondola 8 preferably being adapted to comfortably receive and accommodate crew members responsible for controlling maneuvering and transporting the air vehicle, and for controlling the lifting and lowering of loads.

### Load Cables

In the preferred embodiment of the present invention, the air vehicle has load cables 10 attached to hardpoints along the underside of the air vehicle in any of several different configurations depending on the rigging necessary to safely support the type of load to be carried, which load cables 10 may be lowered (and raised) by way of controls and lifting equipment and machinery positioned within the gondola 8, for lifting and transporting loads such as the container 12 illustrated in FIG. 1, it being understood that various different types of loads may be lifted and transported as would be understood by a person skilled in the art. In the preferred embodiment of the present invention, additional cables (not shown) may also extend from the gondola or from other points on the air vehicle, for the purposes of securing the air vehicle to the ground 14 or another grounded object when the air vehicle is to remain stationary. In one embodiment of the present invention, a mooring winch (not shown) is provided which may be utilized to assist in precisely positioning the air vehicle as needed.

### Airframe

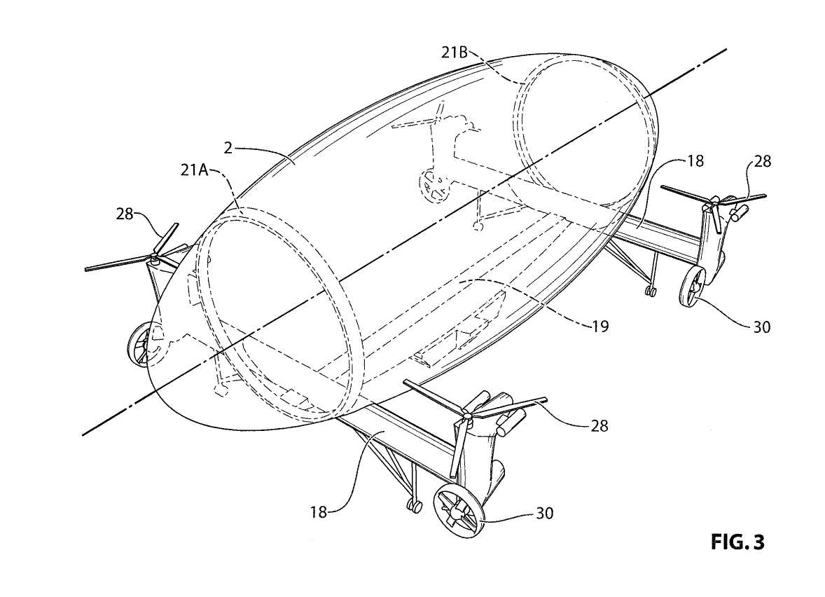

In a preferred embodiment of the present invention, as illustrated in FIG. 3, an airframe is provided, consisting of, for example, horizontal support members 18, a keel 19 and in one embodiment of the present invention, two or more hoop frames as hereinafter described.

### Keel

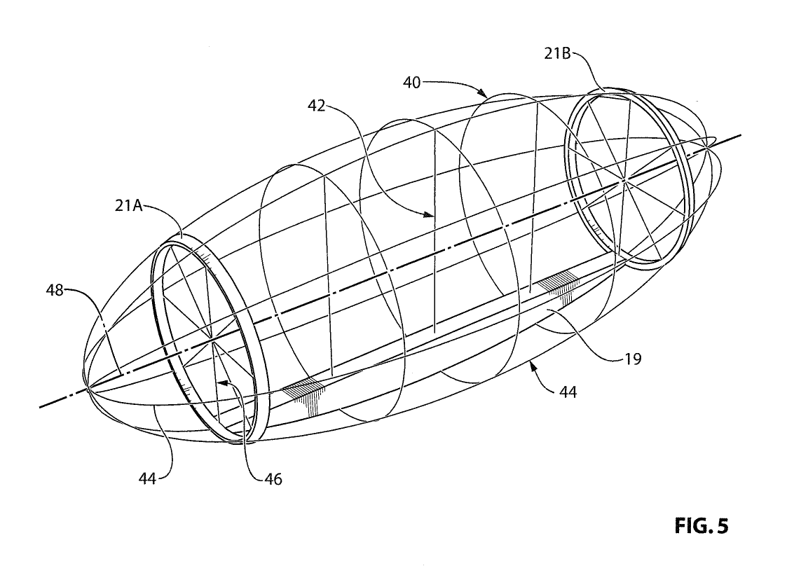

In a preferred embodiment of the present invention, as illustrated in FIGS. 3 and 5, a structural keel 19 extends along a length of the lower side of the envelope, the keel 19 being preferably made of aluminum or composite material, the keel 19 providing structural support for the gondola, the horizontal support members and the lifting cables, and in one embodiment of the present invention, the hoop frames 21A and 21B, and the structural cables as hereinafter described. In an alternative embodiment of the present invention no keel is provided, alternative means such as cables and truss members being provided to support the gondola, and to provide structural support for the horizontal support members, the hoop frames and the structural cables.

### Horizontal Support Members

In a preferred embodiment of the present invention, as illustrated in FIGS. 1 and 3, front and rear horizontal support members 18 extend from both sides of the air vehicle, which horizontal support members 18 are preferably made of aluminum or composite material and are securely and preferably permanently connected to the keel 19 which extends between the two horizontal support members, the horizontal support members 18 preferably supporting the vertical thrusters, the lateral thrusters and landing gear as hereinafter described. In an alternative embodiment of the present invention, only one horizontal support member 18 extends from both sides of the air vehicle and in a further alternative embodiment of the present invention, more than two horizontal support members 18 extend from both sides of the air vehicle.

### Airfoil

In one embodiment of the present invention, the exposed lengths of the horizontal support members have a wing or airfoil shape oriented so as to provide supplemental lift as the air vehicle travels in a forwardly direction. In another embodiment of the present invention, one or more supplemental horizontal members (not shown) are provided which do not support vertical or horizontal thrusters, but which rather have a wing or airfoil shape oriented to provide supplemental lift as the air vehicle travels in a forwardly direction. In a further alternative embodiment of the present invention, the keel may be extended out horizontally beyond the envelope on each side of the air vehicle, the keel extension having an air foil shape and being positioned so that as the air vehicle travels in a forwardly direction, the air through which the air vehicle passes acts upon the airfoil shape of the keel extension to provide supplemental lift to the air vehicle.

### Vertical Thrusters

In a preferred embodiment of the present invention, the air vehicle has four variable and reversible vertical thrusters 28 (it being understood that fewer than four or more than four vertical thrusters may be utilized in accordance with the present invention with appropriate modifications thereto), the variable and reversible vertical thrusters 28 are preferably variable and reversible pitch rotors or propellers (or other propulsive device) each driven by, for example, a gas turbine engine 29 (directly, or preferably by way of a gearbox or power transfer case in a manner known to a person skilled in the art), which gas turbine engine is either vertically or horizontally oriented, it being understood that when a horizontally oriented gas turbine engine is utilized, a power transfer case adapted to convert the power output from the horizontal shaft of the gas turbine engine to the vertical shaft of the variable pitch propellers or rotors is utilized. In one embodiment of the present invention, the vertical thrusters and their corresponding gas turbine engines are cross-connected in pairs so that each gas turbine is capable of powering both vertical thrusters in the cross-connected pair in the event that the other gas turbine in the cross-connected pair experiences engine failure. In the preferred embodiment of the present invention, two of the four vertical thrusters are counter-rotating relative to the other two vertical thrusters (and most preferably, the diagonally opposite vertical thrusters rotate in the same direction) to substantially reduce or eliminate net torque transfer from the vertical thrusters to the air vehicle.

In a preferred embodiment of the present invention, each rotor preferably has multiple rotor blades (and preferably three rotor blades, it being understood that more than three rotor blades may be utilized in accordance with the present invention with appropriate modifications thereto) each of which is preferably airfoil-shaped, each rotor blade preferably being a helicopter rotor blade, and in one embodiment of the present invention, each rotor blade being a 30 foot Boeing Model 234 helicopter rotor blade, it being understood that a wide range of differently shaped and sized rotor blades may be utilized in a manner known to a person skilled in the art. In one embodiment of the present invention, pitch control of the rotor blades is provided using a swash plate arrangement similar to that used in modem helicopters to direct and control the thrust of the rotor as desired. It should also be understood that it is conceivable that the variable and reversible vertical thrusters could be rotated in such a manner as to provide for vertical thrust vectoring/rotation, so as to provide directional control and stability as well as lift, as would be apparent to one skilled in the art.

In one embodiment of the present invention, the rotor or propeller of the variable and reversible vertical thruster is driven by a gas turbine engine located at a distance from the variable and reversible vertical thruster, for example, within the air vehicle structure, and connected by gearbox, power transfer case and drive shaft to the rotor or propeller. In one embodiment of the present invention, one engine may drive all four vertical thrusters, or two or more engines may drive all four vertical thrusters, or each vertical thruster may be driven by its own engine.

In one embodiment of the present invention, each vertical thruster is propelled by a Avco Lycoming AL-5512 engine generating approximately 4,335 SHP, it being understood that a wide range of alternative engines, engine sizes and engine configurations may be utilized, depending on, for example, the load capacity of the air vehicle and such other factors as would be known to a person skilled in the art.

### Lateral Thrusters

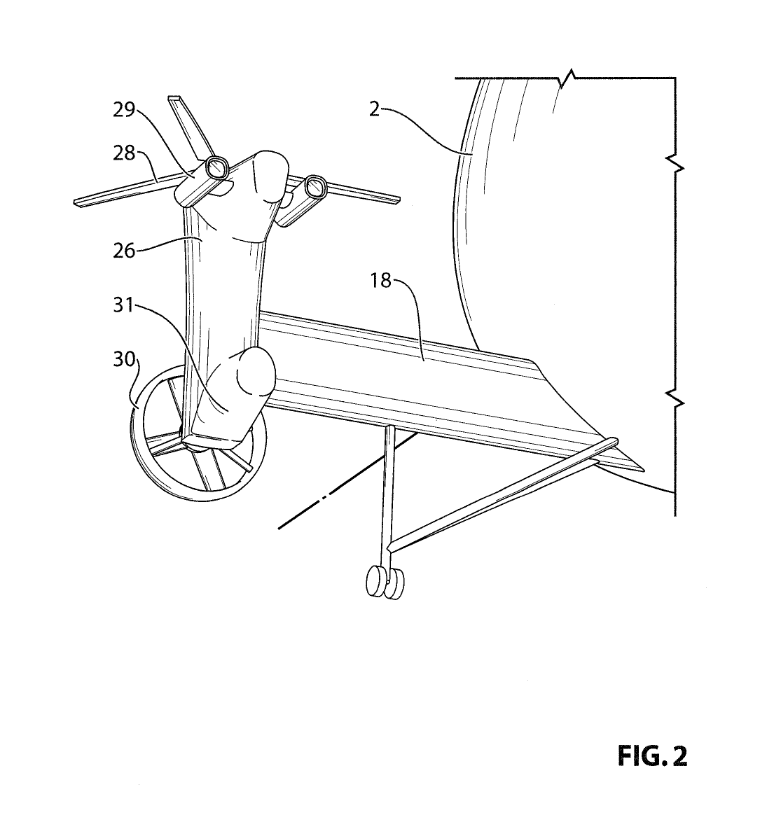

Preferably, the air vehicle has four independently controllable variable and reversible lateral thrusters (it being understood that fewer than four or more than four lateral thrusters may be utilized in accordance with the present invention with appropriate modifications thereto) the variable and reversible lateral thrusters 30 may be ducted fans or propellers (or other propulsive device) and are preferably ducted fans 33 driven by gas turbine engine 31 as illustrated in FIGS. 1 and 2 (the ducted fans being driven directly, or preferably by way of a gearbox or power transfer case in a manner known to a person skilled in the art). In the preferred embodiment of the present invention, a Pratt & Whitney PT-6 gas turbine engine generating approximately 1000 SHP is used to drive each of the lateral thrusters, it being understood that a wide range of alternative engines, engine sizes and engine configurations may be utilized, depending on, for example, the size and load capacity of the air vehicle and such other factors as would be known to a person skilled in the art. In the preferred embodiment of the present invention, as illustrated in FIG. 1, two diagonally opposite lateral thrusters are independently controllable and oriented to provide forward and reverse directed thrust, and the other two diagonally opposite lateral thrusters are independently controllable and oriented to provide sideways thrust so that the air vehicle can be readily maneuvered as needed.

In the preferred embodiment of the present invention, the lateral thrusters are located beneath the vertical thrusters to lower the overall center of gravity of the air vehicle, it being understood that the lateral thrusters could be positioned at other points on the air vehicle to provide controllable and maneuverable thrust for maneuvering and transporting the air vehicle, it also being understood that the lateral thrusters can be configured, for example where each lateral thruster is attached to a horizontal structural member 18 using a gimble joint assembly (not shown) so that the thrust from each lateral thruster can be independently vectored to provide additional directional control for the thrust generated by the lateral thruster. In a further alternate embodiment of the present invention, the thrust of each lateral thruster may be vectored by employing independently controlled directional vanes (not shown) positioned behind the lateral thrusters 30 so as to direct the thrust as needed or desired.

### Vertical and Horizontal Thruster Assemblies

It is understood that the power plants, gearboxes, and driveshafts used to drive the vertical and horizontal thrusters may be arranged in a variety of ways suited for their intended purpose as described herein. In the preferred embodiment of the present invention, four vertical and horizontal thruster assemblies 16 shown in FIGS. 1 and 2 are attached to the distal end of the horizontal structural members 18, where the vertical and horizontal thruster assembly consists of a vertical structure members 20, 22, 24 and 26 having vertical thruster 28 and associated power plant, gearboxes and drive shafts attached at the top and having lateral thruster 30 and associated power plant, gearboxes and drives shafts attached at the bottom.

### Landing Gear

In a preferred embodiment of the present invention, landing gear 32, preferably clusters of wheels, skis or skids (not shown), pontoons or supporting legs (not shown) extend from beneath the horizontal support members as illustrated in FIG. 1, and in one embodiment of the present invention, the landing gear may be retracted to a position within the air vehicle when not in use.

### Hoop Frames

As illustrated in FIGS. 3 and 5, in the preferred embodiment of the present invention, two or more hoop frames 21 preferably made of aluminum or composite material are positioned a distance from one another and from either end of the envelope are attached to the keel, providing structural integrity to the envelope 2 and load/weight transfer/distribution between the envelope and the keel. In the preferred embodiment of the present invention, a forward hoop frame 21A and rearward hoop frame 21B is positioned approximately ¼ and ¾ of the distance from the front of the envelope, respectively, providing a semi-rigid envelope, it being understood that one or more additional hoop frames can be added to provide further increased structural integrity, and in one embodiment of the present invention, an additional middle hoop frame is positioned approximately ½ of the distance from the front of the envelope. In a further alternative embodiment of the present invention, no hoop frames are utilized, the air vehicle having a wholly or substantially non-rigid envelope.

### Structural Cables

As illustrated in FIG. 5, in one embodiment of the present invention, three hoop cables 40 are positioned a distance from one another within and securely fastened to the inner surface of the envelope and at the bottom, to the keel, providing structural integrity and load/weight transfer and distribution to the envelope. Additionally three vertical cables 42 are positioned to extend from the uppermost point of each of the hoop cables, to the keel 19, to provide additional structural integrity and load/weight transfer and distribution to the envelope. Additionally eight external longitudinal cables 44 spaced at 45 degrees along the long axis of the envelope and securely fastened to the inner surface of the envelope extend from the front to the back of the envelope are adapted to maintain the overall shape of the envelope against the pressure of the helium gas. Additionally eight radially arrayed cables 46 are provided and attached to each hoop frame, the point of intersection of the cables corresponding to the centerline 48 (long axis) of envelope to maintain geometry and structural integrity of the hoop frames 21A and 21B.

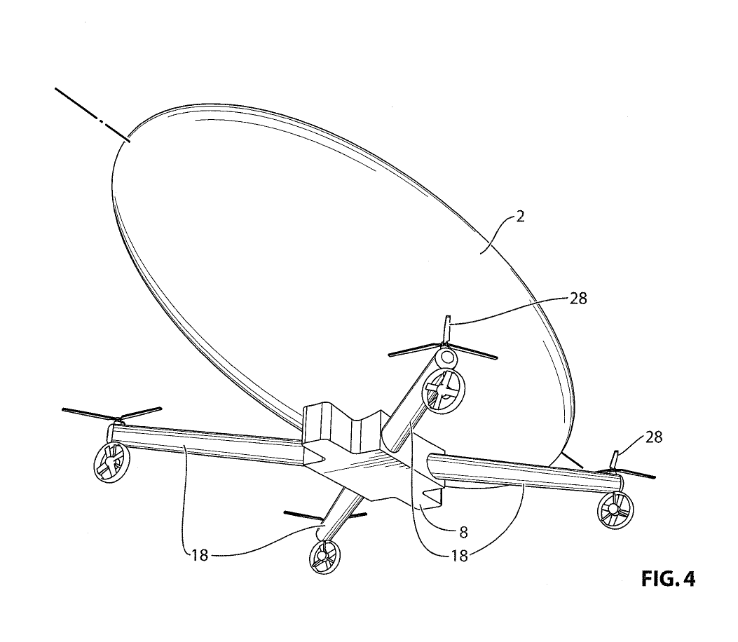

In a further alternative embodiment of the present invention, as illustrated in FIG. 4, four horizontal members 18 are provided which support the vertical thrusters, the lateral thrusters and landing gear previously described, which horizontal members are centrally connected as illustrated in FIG. 4, and which are attached to and extend outwardly from the keel 19 previously described.

While the preferred embodiment of the present invention has been described where the buoyancy of the helium gas fully or substantially offsets the weight of the air vehicle when unloaded, it is understood that in alternative embodiments of the present invention, the air vehicle may be somewhat positively buoyant (that is, the buoyancy of the helium gas more than offsets the weight of the air vehicle when unloaded), which positive buoyancy may be offset by ballonets, ballast or upwardly directed thrust from rotors 28, it also being understood that in a further alternative embodiment, the air vehicle may be somewhat or significantly negatively buoyant (that is, the buoyancy of the helium gas does not fully or substantially offset the weight of the air vehicle when unloaded), which negative buoyancy may be offset by downwardly directed thrust from rotors 28.

In an alternative embodiment of the present invention, a pill-shaped or helipsoidally-shaped envelope may alternatively be used in place of the generally ellipsoidally-shaped envelope described herein.

In a further alternative embodiment of the present invention, the envelope may be rigid, semi-rigid or non-rigid, which alternative embodiments may be constructed in a manner known to a person skilled in the art.

In a further alternative embodiment of the present invention, additional air flow and control features may be provided, including for example, horizontal and vertical stabilizers, elevator, and rudder (not shown), located at the rear of the envelope 2.

In a further embodiment of the present invention, lighting (not shown) such as that used in a stadium may be positioned on the air vehicle to illuminate the load and the ground beneath the air vehicle for use, for example, at night, dusk and during inclement weather.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A hybrid air vehicle for carrying a load comprising:
an envelope adapted to receive a volume of lighter-than-air gas, the envelope having one of an ellipsoidal shape, helipsoidal shape, and pill shape, the volume of the lighter-than-air gas having a buoyancy sufficient for offsetting at least 25% of the weight of the hybrid air vehicle when unloaded;
at least two variable thrust vertical thrusters in secure engagement with the envelope and placed at a substantial distance to a center of gravity of the hybrid air vehicle for raising and lowering the hybrid air vehicle and the load; and, at least two variable thrust lateral thrusters in secure engagement with the envelope.

2. A hybrid air vehicle for carrying a load as defined in claim 1 wherein the vertical thrusters and the lateral thrusters are mounted to horizontal support members extending from both sides of the envelope.

3. A hybrid air vehicle for carrying a load as defined in claim 2 wherein the lateral thrusters are placed beneath the vertical thrusters.

4. A hybrid air vehicle for carrying a load as defined in claim 2 wherein the hybrid air vehicle comprises:
two diagonally opposite lateral thrusters for providing forward and reverse directed thrust; and,
two diagonally opposite lateral thrusters for providing sideway thrust.

5. A hybrid air vehicle for carrying a load as defined in claim 2 wherein the thrust of each lateral thruster is independently directional controllable.

6. A hybrid air vehicle for carrying a load as defined in claim 2 wherein the hybrid air vehicle comprises four vertical thrusters and wherein two of the four vertical thrusters are counter-rotating relative to the other two vertical thrusters such that diagonally opposite vertical thrusters rotate in the same direction.

7. A hybrid air vehicle for carrying a load as defined in claim 2 wherein each of the vertical thrusters comprises multiple helicopter rotor blades.

8. A hybrid air vehicle for carrying a load as defined in claim 2 comprising a structural keel in secure engagement with the envelope and having the horizontal support members mounted thereto, the structural keel extending along a length of the bottom of the envelope.

9. A hybrid air vehicle for carrying a load as defined in claim 2 comprising at least two hoop frames attached to the structural keel for providing secure engagement of the structural keel with the envelope.

10. A hybrid air vehicle for carrying a load as defined in claim 8 wherein the structural keel comprises a keel extension extending horizontally beyond the envelope, the keel extension having a shape and being positioned such that lift is provided during forward movement of the hybrid air vehicle.

11. A hybrid air vehicle for carrying a load as defined in claim 2 wherein exposed lengths of the horizontal support members have a shape such that lift is provided during forward movement of the hybrid air vehicle.

12. A hybrid air vehicle for carrying a load as defined in claim 3 wherein one vertical thruster and one lateral thruster are mounted to a distal end of each of the horizontal support members.

13. A hybrid air vehicle for carrying a load as defined in claim 8 wherein the structural keel provides support for a gondola and lifting cables.

14. A hybrid air vehicle for carrying a load as defined in claim 1 comprising at least a ballonet disposed within the envelope.
